(19) United States
(12) Patent Application Publication
(10) Pub. No.: US 2007/0020581 A1
(43) Pub. Date: Jan. 25, 2007

(54) Apparatus and method for installing and removing crowns from abutments

(76) Inventor: George M. Whitehead, Lynnwood, WA (US)

Correspondence Address: DEAN A. CRAINE, 400- 112TH AVE., STE. 140, BELLEVUE, WA, 98004, US

(21) Appl. No.: 11/189,570

(22) Filed: Jul. 25, 2005

(51) Int. Cl. A61C 3/02

(52) U.S. Cl. 433/144; 433/147

(57) ABSTRACT

Apparatus and system for easily removing a dental crown from an abutment attached to an implant inserted to the jawbone of a patient without disturbing the implant. The apparatus includes an elongated handle, an intermediate member and crown-lifting member. The intermediate member is inserted into a passageway formed in the distal end of the elongated handle. The intermediate member extends substantially downward and perpendicular aligned with the distal end of the elongated handle. The opposite, distal end of the intermediate member is connected to the proximal end of the crown-lifting member. Formed on the crown-lifting member is a slotted head that fits into a full slot opening formed on the lingual sides of the crown and abutment. During use, the elongated handle is inserted into the patient's mouth with the intermediate member extending downward and aligned on the lingual side of the jawbone. The crown-lifting member is perpendicularly aligned and extends laterally into the full slot opening. When the elongated handle is moved back and forth through the mouth, the crown-lifting member slowly rotates inside the full slot to lift the crown off the abutment.

### BACKGROUND OF THE INVENTION

1. Field of the Invention

This invention relates to dental implants and abutments and, more particularly, to apparatus for removing crowns from dental implants and abutments.

2. Description of the Related Art

It is widely known that dental implants can be easily dislodged from the jawbones. Because a crown is typically adhesively attached to the top surface of an abutment that is threadingly attached to the implant, great care must be exercised when removing the crown from the abutment so that the implant is not dislodged from the jawbone. Typically, dentists use two small pliers or clamps to securely hold the abutment and the implant in the jawbone and then slowly remove the crown. Unfortunately, the implant is often dislodged from the jawbone during the process.

U.S. Pat. Nos. D471,629; D477,667; D477,877; D477,879; D477,876; D477,878; D482,450; D493,535; D493,891; and D494,275 disclose various dental implants with upward extending half slots formed on the lingual sides of their abutment attached thereto. The abutments are used with a customized crown that include a downward extending complimentary half slot formed on it's lingual sides that are aligned and registered with the half slot formed on the abutment. When the crown is properly attached to the abutment, the two half slots are aligned and form a single full slot capable of receiving the tip of a knife or screwdriver to remove the crown from the abutment.

Unfortunately, inserting the top of a knife or screwdriver into the full slot at a correct angle is difficult and often results in the implant being dislodged from the jawbone.

### SUMMARY OF THE INVENTION

It is an object of the present invention to provide a hand tool that can be easily inserted to a full slot formed on the lingual sides of a crown and abutment.

It is another object of the invention to provide such a hand tool that includes a crown-lifting member that can be perpendicularly aligned on the lingual side of the lower bridge that can be easily inserted into the full slot formed between the crown and the abutment.

These and other objects are met by the apparatus and system disclosed herein for safely removing a dental crown from an abutment without dislodging the dental implant inserted in the patient's jawbone. The apparatus includes an elongated handle, an intermediate member, and a crown-lifting member. The elongated handle is sufficient in length so that its proximal end extends through the mouth while its distal end is disposed adjacent to the lingual side of the jawbone. The intermediate member is perpendicularly aligned and extends downward from the distal end of the handle. The crown-lifting member is perpendicularly aligned with both the handle and the intermediate member and during use, extends inward and fits into the full slot formed by the crown and the abutment.

The crown and abutment have complimentary downward extending and upward extending half-slot openings, respectively, formed on their lingual surface of the abutment are shown in U.S. Pat. Nos. D471,629; D477,667; D477,877; D477,879; D477,876; D477,878; D482,450; D493,535; D493,891; and D494,275. When the distal end of the blade on the crown-lifting member is inserted into the full slot opening and the handle is pushed and pulled through the mouth, the intermediate member slightly rotates on the distal end of the elongated handle hereby allowing the crown-lifting member to rotate inside the full slot to gently lift and dislodge the crown from the abutment.

In one embodiment, the blade on the crown-lifting member is a rectangular when viewed in a cross-section. In another embodiment, the blade on the crown-lifting member is a semi-circle in cross-section with a flat top surface and a semi-circular bottom surface.

Also disclosed herein is a method for removing a crown from an abutment.

### DESCRIPTION OF THE DRAWINGS

FIG. 1 is a perspective view of the apparatus being used to remove a crown from an abutment.

FIG. 2 is a perspective view of the apparatus.

FIG. 3 is a top plan view of the apparatus.

FIG. 4 is a right side elevational view of the apparatus.

FIG. 5 is an exploded perspective view of the apparatus.

FIGS. 6 and 7 are sectional, side elevational views showing the movement of the intermediate member inside the cavity formed in the elongated handle when the elongated handle is moved back and forth through the mouth.

FIG. 8 is an exploded perspective view of a crown with a one-half slot opening formed on its lingual side being disposed over an abutment with a complimentary-shaped one-half slot opening.

FIG. 9 is a side elevational view of the crown and abutment shown in FIG. 8 being attached to form a full slot opening.

FIG. 10 is a sectional side elevational view taken along Line 10-10 in FIG. 9.

FIG. 11 is a sectional side elevational view of the rectangular-shaped member placed inside the full slot opening and formed by the crown and the abutment with the crown-lifting member being rotated to lift the crown off the abutment.

FIG. 12 is a perpendicular view of a second embodiment of the crown-lifting member.

FIG. 13 is a sectional side elevational view of a crown placed over an abutment, with the second embodiment of the crown-lifting member inserted into the full slot and rotated to lift the crown off the abutment.

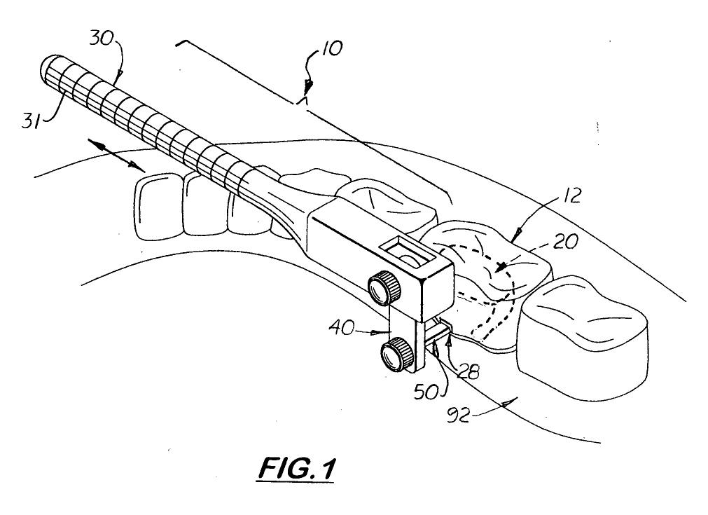

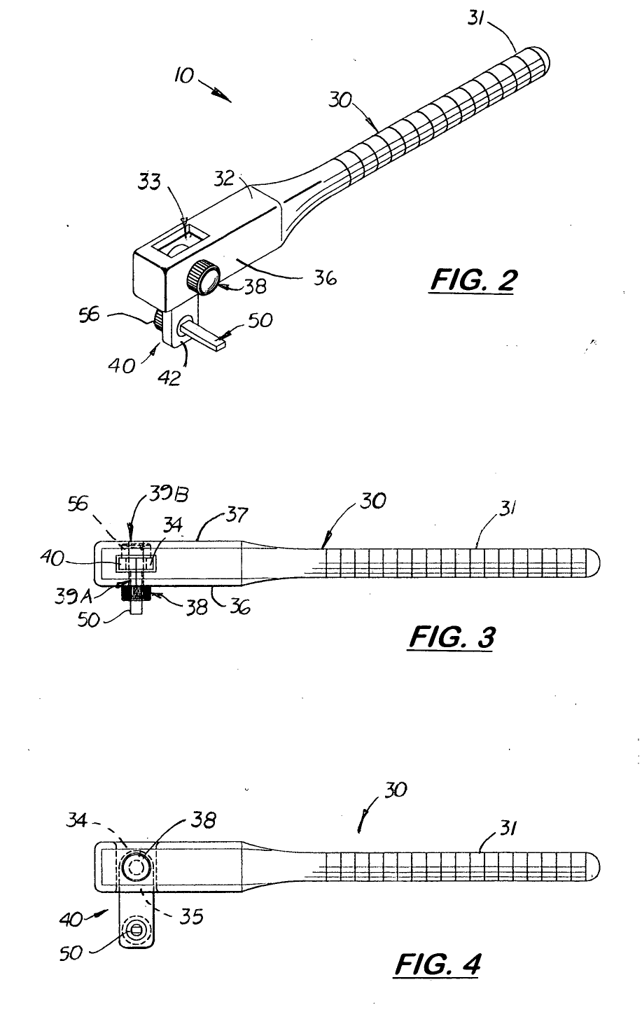

### DESCRIPTION OF THE PREFERRED EMBODIMENT(S)

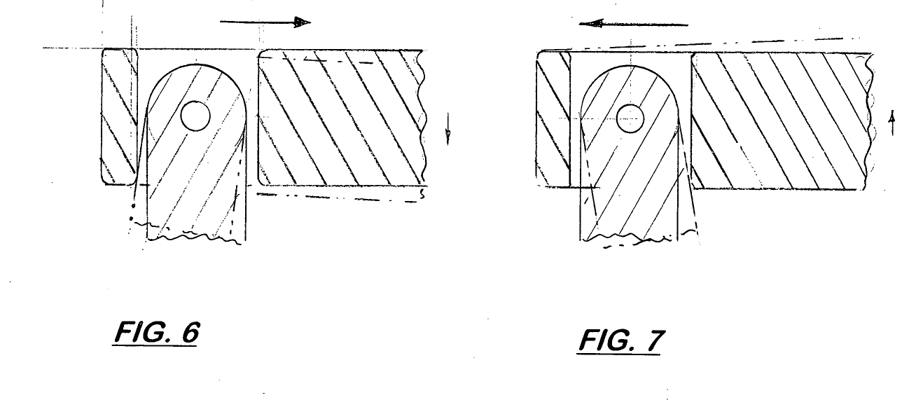

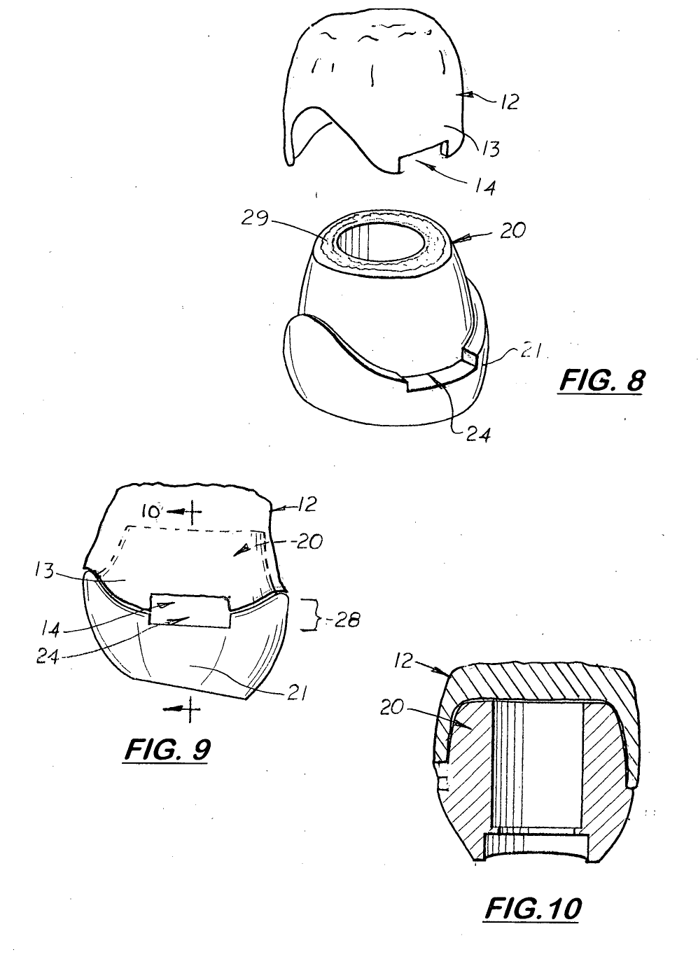

The apparatus 10 for removing a dental crown 12 from an abutment 20 attached to an implant (not shown) inserted into a patient's jawbone 92. The apparatus 10 comprises an elongated handle 30, a short intermediate member 40 and crown-lifting member 50. As shown in FIGS. 6 and 7, the dental crown 12 and abutment 20 each include a complimentary shaped one-half slot opening 14, 24 formed on their lower lingual edges 13, 21, respectively. The abutments 20 (also called implant substructures) are disclosed in Applicant's previous issued patents, D471,629; D477,667; D477,877; D477,879; D477,876; D477,878; D482,450; D493,535; D493,891; and D494,275 and now incorporated herein. During installation, the crown 12 and abutment 20 are aligned so that their two one-half slot openings 14, 24 are aligned and registered to create a full slot opening designated 28, on their lingual sides. A suitable adhesive 29 is used to securely attach the crown 12 to the abutment 20.

The apparatus 10 includes an elongated handle 30, an intermediate member 40, and a crown-lifting member 50. The elongated handle 30 includes a narrow handle 31 and an integrally formed wide head 32. Located in the wide head 32 is a perpendicular aligned, rectangular shaped passageway 33 with opposite top and bottom openings 34, 35. Perpendicularly mounted on one side 36 of the wide head 32 is a non-threaded bore 39A that receives a threaded screw 38 that extends transversely through the passageway 33. The distal end of the threaded screw 38 connects to a threaded bore 39 formed on the opposite side 37 of the head 32.

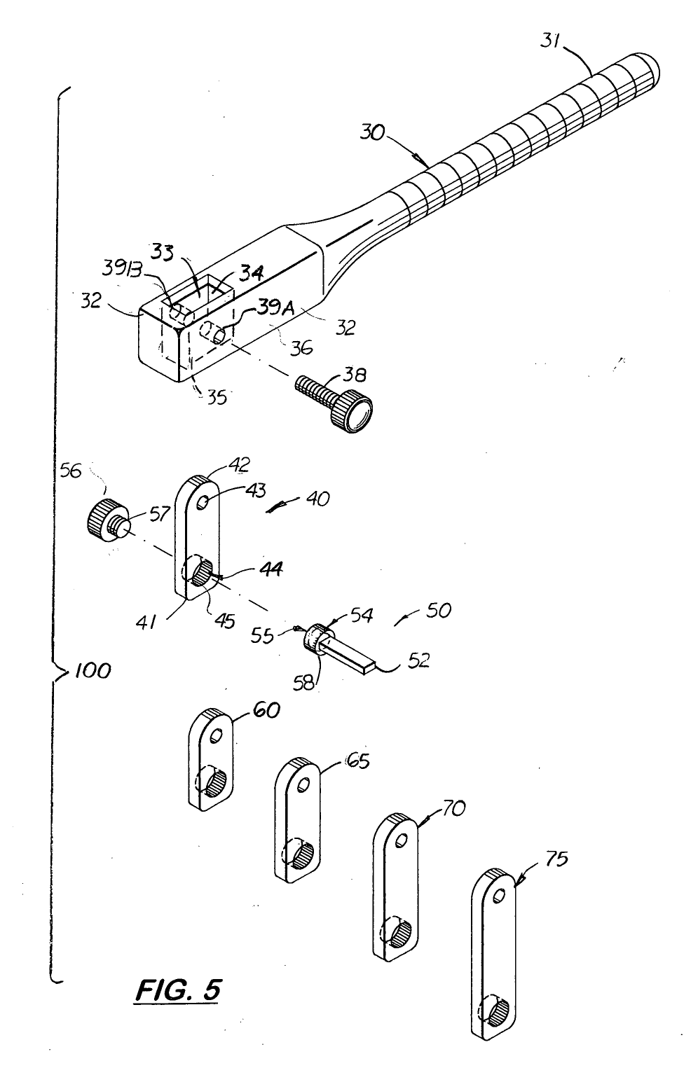

The intermediate member 40, shown more clearly in FIG. 5, is a relatively short structure that extends downward from the passageway 33. The width of the intermediate member 40 is slightly smaller that the passageway 33 so that the intermediate member 40 rotates approximately 20 degrees on opposite sides of the passageway's vertical axis. Formed on the proximal end 42 of the intermediate member 40 is a bore 43 designed to receive the threaded screw 38. Bore 43 is slightly larger in diameter than the screw 39 so that the intermediate member 40 pivots freely around the screw 39. Formed on the distal end 41 of the intermediate member 40 is a perpendicularly aligned bore 44 designed to receive a perpendicularly aligned crown-lifting member 50.

The crown-lifting member 50 includes a cylindrical head 54 with a threaded bore 55 formed therein designed to attach to the external threads 57 on an attachment screw 56. The attachment screw 56 is positioned on opposite sides of the intermediate member 40 and extends through the bore 44. Formed on the outer surface of the head 54 is a plurality of splines 58 designed to engage complimentary splines 45 formed on the inside surface of the bore 44.

As shown in FIG. 5, the handle 30, and the intermediate members 40 are sold and distributed as a set denoted 100, containing a plurality of different length intermediate members 40, 50, 60, 65, 70. The different crown-lifting members 40-70 are identical except being different lengths. Providing a set 100 with intermediate members having different lengths is useful because they allow the dentist to adjust the relative position of the crown-lifting member 50 with respect to the elongated handle 30 for use on patients with different mouth sizes and implant.

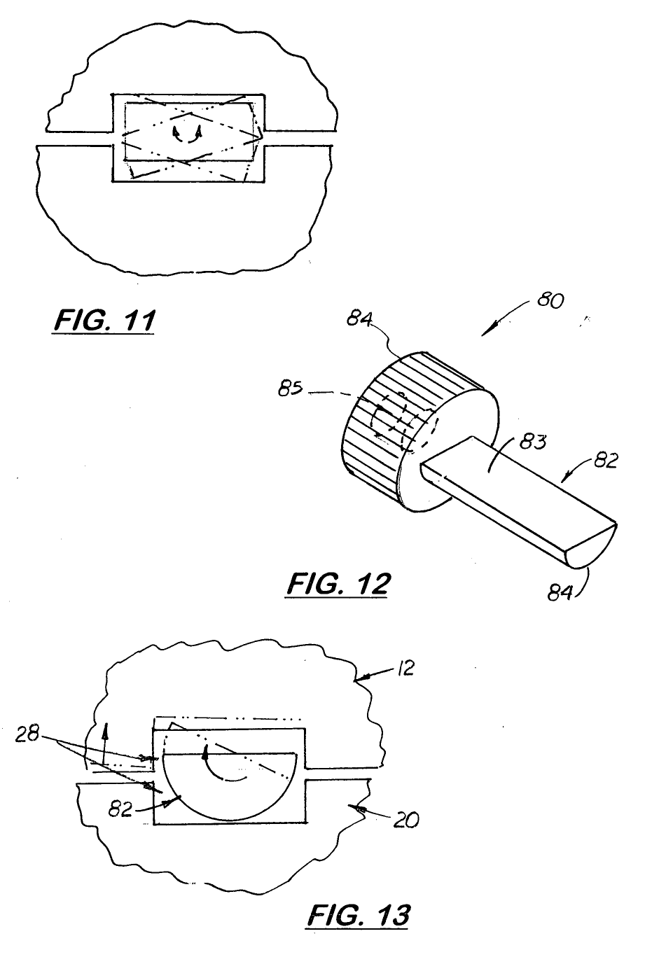

In the first embodiment, the crown-lifting member 50 is an elongated structure, rectangular in cross section. When the crown-lifting member 50 is inserted into the full slot opening 28 and the elongated handle 30 pushed or pulled through the mouth, the intermediate member 40 rotates inside the passageway 33 and around the screw 38. Because the blade 52 of the crown-lifting member 50 is attached to the distal end of the intermediate member 40, the blade 52 rotates inside the full slot 28 as shown in FIG. 11. In a second embodiment of the crown-lifting member designated 80, shown in FIGS. 12 and 13 the blade 82 has a flat top surface 83 and a semi-circular bottom surface 84. When crown-lifting member 80 is inserted into the full slot opening 28, the bottom surface 84 rolls over the lower surface of the abutment 20 and gently lifts the crown 12. During assembly, the intermediate member 40 extends substantially downward from the passageway 33. The screw 38 is then used to hold the intermediate member 40 in place inside the passageway 33. Because the intermediate member 40 rotates around the screw 38. The front and rear end walls inside the cavity limit the rotation of the intermediate member 40 on the elongated handle 20. The head 54 of the crown-lifting member 50 or 80 is then inserted into the bore 44. The attached screw 56 is then attached to the crown-lifting member 50 to securely attach the crown-lifting member 50 or 80 to the intermediate member 40. The apparatus 10 is then inserted into the patient's mouth so that the proximal end 31 of the handle 30 extends from the mouth, the intermediate member 40 extends downward and is aligned on the lingual side of the bridge 92, and the blade 52 on the crown-lifting member 50 is placed inside the full slot opening 28 formed between the lingual sides of the crown 12 and abutment 20.

In the preferred embodiment, the height of the two-half slot openings and the height of the blade 52 are sufficient so that the blade's mid-line axis is aligned with the gap formed between the lower edge of the crown 12 and the upper edge lengths of the abutment 20. The intermediate members 40 are 8 to 18 millimeters (mm) in length. The blade 52 on each intermediate member 40 are approximate 1×2×5 mm (H×W×D).

In compliance with the statute, the invention described herein has been described in language more or less specific as to structural features. It should be understood, however, that the invention is not limited to the specific features shown since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. Apparatus for removing a dental crown from an abutment attached to a dental implant inserted in a patient's jawbone, said dental crown and said abutment each having complimentary-shaped half slot openings which form a full slot opening when said dental crown is attached over said abutment, said apparatus comprising;
a. an elongated handle having a handle portion and a head portion;
b. an intermediate member perpendicularly aligned and attached to said head portion, said intermediate member including a distal end; and,
c. at least one crown-lifting member perpendicularly aligned with and attached to said distal end of said intermediate member, said crown-lifting also perpendicular to said elongated handle, said crown-lifting member including a head at one end and a blade at the opposite end, said blade capable of being inserted into a full slot formed between the crown and an abutment when the crown is attached to the abutment.

2. The apparatus, as recited in claim 1, wherein said blade on said crown-lifting member is a parallelogram when viewed in cross-section.

3. The apparatus, as recited in claim 1, wherein said blade includes a semi-circular bottom surface and a flat top surface.

4. The apparatus, as recited in claim 1, wherein said elongated handle includes a cavity in which said intermediate member is inserted when said intermediate member is attached to said elongated handle.

5. The apparatus, as recited in claim 4, further including a cavity formed on said head portion of said elongated handle in which said intermediate member is inserted.

6. The apparatus, as recited in claim 5, further including a threaded screw attached to said head portion and a bore formed on said intermediate member, said threaded pin extending transversely through said cavity and through said bore to selectively attach said intermediate member to said cavity.

7. The apparatus, as recited in claim 1, further including means for selectively attaching said crown-lifting member to said intermediate member.

8. The apparatus, as recited in claim 7, wherein said means for selectively attaching said crown-lifting member to said intermediate member is a cylindrical head formed on said crown-lifting member opposite said blade and a bore formed on said distal end of said intermediate member capable of receiving said head, and an attached screw used to hold said head inside and attach said crown-lifting member on said intermediate member.

9. The apparatus, as recited in claim 5, wherein said intermediate member is able to rotate approximately 20 degrees in opposite direction around the center axis of said cavity.

10. The apparatus, as recited in claim 9, further including said means to allow said crown-lifting member to be selected, rotated and locked in different positions and said intermediate member thereby enabling said handle to be disposed in different positions with respect to said crown-lifting member, when said crown-lifting member is inserted into a full slot on said tooth.

11. A method for removing a dental crown from an abutment in a patient's mouth, comprising the following steps:
a. selecting an apparatus for removing the crown from an abutment, said apparatus includes an elongated handle having opposite distal and opposite ends, an intermediate member perpendicularly aligned and pivotally attached to said distal end of said elongated handle, means for selectively attaching said intermediate member to said elongated handle, a crown lifting member perpendicularly aligned with said intermediate member, said crown lifting member including a blade capable of being inserted into a slot formed between a dental crown and an abutment;
b. inserting the blade on said crown lifting member into the slot formed between said abutment and said dental crown, and;
c. sufficiently moving said elongated handle inward and outward from the mouth so that said blade moves within said slot to dislodge said dental crown from said abutment.

12. A system for installing a dental crown from an abutment in a patient's mouth, comprising the following steps:
a. an abutment attached to an implant, said abutment including a slot opening formed on its one surface;
b. a crown disposed over said abutment, said crown including a clot opening that is aligned and registered over said slot opening formed on said abutment;
c. selecting an apparatus including an elongated handle having opposite distal and opposite ends, an intermediate member perpendicularly aligned and pivotally attached to said distal end of said elongated handle, means for selectively locking said intermediate member to said elongated handle, a crown lifting member perpendicularly aligned with said intermediate member, said crown lifting member including a slotted head capable of being inserted into the slots formed between said dental crown and said abutment, and means for selectively attaching said crown lifting member to the end of said intermediate member opposite said elongated handle.
d. inserting the slotted head on said crown lifting member into a slot located between said abutment and said dental crown, and;
e. moving said elongated handle inward and outward from the mouth to dislodge said dental crown from said abutment.
